(19) United States
(12) Patent Application Publication
(10) Pub. No.: US 2009/0290548 A1
(43) Pub. Date: Nov. 26, 2009

(54) APPARATUS AND METHOD FOR MANAGING WIRELESS RESOURCES

(76) Inventors: Sang-Hoon Lee, Seoul (KR); Hyung-Keuk Lee, Seoul (KR)

Correspondence Address: LADAS & PARRY LLP, 224 SOUTH MICHIGAN AVENUE, SUITE 1600, CHICAGO, IL, 60604, US

(21) Appl. No.: 12/441,403

(22) PCT Filed: Apr. 26, 2007
(86) PCT No.: PCT/KR2007/002046

§ 371 Date: Mar. 16, 2009

(30) Foreign Application Priority Data
Sep. 19, 2006 (KR) 10-2006-0090440

(51) Int. Cl. H04W 72/00; G06F 15/173

(52) U.S. Cl. 370/329; 709/223

(57) ABSTRACT

The present invention relates to an apparatus and method for managing wireless resources, which can provide a service to improve transmission efficiency when multimedia data is transmitted in a mobile communication system. The wireless resource management apparatus includes a data analysis unit (110) for separating data into a plurality of bit stream layers, which form a layered structure, by analyzing the data according to a predetermined rule, and for detecting amounts of information of respective bit stream layers. A wireless resource allocation unit (130) allocates the bit stream layers to frequency bands based on the amounts of information of the bit stream layers detected by the data analysis unit. The present invention is advantageous in that it can reduce inter-cell interference from the standpoint of an application layer that directly influences users.

### TECHNICAL FIELD

The present invention relates, in general, to an apparatus and method for managing wireless resources and, more particularly, to an apparatus and method for managing wireless resources, which can provide a service to improve transmission efficiency when multimedia data is transmitted in a mobile communication system.

### BACKGROUND ART

Most of the causes of the decrease in communication performance in wireless communication technology based on a multi-cell environment can be considered to be Inter-Cell Interference (hereinafer referred to as ‘ICI’). This is particularly serious for users located in the outer portion of a cell, and becomes the cause of decreasing the performance of the entire cell.

In particular, in the case of multimedia service of providing high-capacity data, since channel capacity that can be guaranteed in the boundary area of a cell suddenly decreases, technology for mitigating ICI is essentially required.

Accordingly, most techniques of managing wireless resources, which are currently being conducted, aim at mitigating ICI and maximizing channel capacity or usefulness for all users located in a cell. In particular, research in cross-layer optimization technology for pursuing optimization between different layers has been conducted.

For example, cross-layer optimization technology includes Joint Source and Channel Coding (JSCC) technology, congestion and routing control technology, congestion and distortion optimization technology, etc.

Such a cross-layer optimization technology is described in detail below. JSCC is a technology for connecting an application layer to a physical layer using a method of strongly applying channel coding to a channel having large errors and increasing quantization parameters for that channel from the standpoint of source coding in consideration of both a source coding technique for the application layer and a channel coding technique for the physical layer. Congestion and routing control technology is a technology for controlling a flow at a location at which congestion occurs by controlling the routing algorithm of a transport layer in order to prevent the loss of performance of the entire network when congestion occurs in a network layer. Congestion and distortion optimization technology is a technology for pursuing cross layer optimization between an application layer and a network or a transport layer, such as by discarding packets within an allowable range of predetermined distortion when a delay greater than a tolerant delay of a packet to be transmitted occurs due to congestion.

However, operators who manage the resources of a radio network are aware that research into a method of managing wireless resources from the standpoint of an application layer which directly influences users is needed, in addition to the above-described wireless resource management technologies.

### DISCLOSURE

### Technical Problem

Accordingly, the present invention has been made keeping in mind the above problems occurring in the prior art, and an object of the present invention is to provide an apparatus and method for managing wireless resource, which reduces inter-cell interference and increases the channel capacity of all cells when multimedia data is transformed, on the basis of the amount of multimedia information in a multi-cell environment.

### Technical Solution

In order to accomplish the above object, the present invention provides an apparatus for managing wireless resources, comprising a data analysis unit for separating data into a plurality of bit stream layers, which form a layered structure, by analyzing the data according to a predetermined rule, and for detecting amounts of information of respective bit stream layers; and a wireless resource allocation unit for allocating the bit stream layers to frequency bands based on the amounts of information of the bit stream layers detected by the data analysis unit.

Further, the present invention provides a method of managing wireless resources in a wireless resource management apparatus for allocating wireless resources to frequency bands according to an amount of information of data transmitted or received in a mobile communication system comprising a first step of the wireless resource management apparatus separating multimedia information into a plurality of bit stream layers, which form a layered structure, using a layered video compression codec capable of separating multimedia information into bit stream layers; a second step of detecting amounts of information of respective bit stream layers separated at the first step, and storing the detected amounts of information in headers of corresponding bit stream layers; and a third step of dividing an entire frequency band by a number of bit sham layers separated at the first step, and allocating the bit stream layers to different frequency bands based on the amounts of information of the bit stream layers detected at the second step, and transmitting the allocated bit steam layers through respective frequency bands.

In addition, the present invention provides a method of managing wireless resources in a wireless resource management apparatus for allocating wireless resources to frequency bands according to an amount of information of data transmitted or received in a mobile communication system, comprising a first step of the wireless resource management apparatus separating multimedia information into a plurality of bit stream layers, which form a layered structure, using a layered video compression codec capable of separating multimedia information into bit stream layers; a second step of detecting amounts of information of respective bit stream layers separated at the first step, and storing the detected amounts of information in headers of corresponding bit stream layers; and a third step of dividing an entire frequency band by a number of bit stream layers separated at the first step, and allocating the bit stream layers to frequency bands having different loading ratios based on the amounts of information of the bit stream layers detected at the second step.

### ADVANTAGEOUS EFFECTS

As described above, an apparatus and method for managing wireless resources according to the present invention is advantageous in that it can reduce interference between cells at the time of transmitting data, from the standpoint of an application layer that directly influences users.

Further, the present invention is advantageous in that it can increase the channel capacity of all cells when data is transmitted.

### DESCRIPTION OF DRAWINGS

FIG. 1 is a diagram showing an example of the use of a typical FRF;

FIG. 2 is a detailed diagram showing the construction of an apparatus for managing wireless resources according to the present invention;

FIG. 3 is a diagram showing a method of allocating bit stream layers to frequency bands;

FIG. 4 is a diagram showing a method of allocating bit steam layers to frequency bands having different subcarrier densities;

FIG. 5 is a diagram showing an example in which the method of FIG. 4 is applied to two cells;

FIG. 6 is a diagram showing an example in which the method of FIG. 3 is applied to multiple cells;

FIG. 7 is a flowchart of a method of managing wireless resources according to an embodiment of the present invention; and

FIG. 8 is a flowchart of a method of managing wireless resources according to another embodiment of the present invention.

### BEST MODE

A method of managing wireless resources disclosed in the present invention is intended to refer to cross-layer optimization technology for approaching the management of wireless resources from the standpoint of an application layer which directly influences users.

Hereinafer, embodiments of the present invention will be described in detail with reference to the attached drawings.

FIG. 1 is a diagram showing an example of a typical Frequency Reuse Factor (FRF).

Techniques for managing wireless resources include various methods, such as cell planning, power control, and scheduling, and most objects of the management of wireless resources are to increase channel capacity in lower layers.

For example, in the case of cell planning, a method using a Frequency Reuse Factor (hereinafter referred to as an ‘FRF’), as shown in FIG. 1, is used.

FRF, which is a parameter used to indicate frequency efficiency in a cellular system, indicates the number of cells into which the entire frequency band is divided. For example, when the total number of given channels is divided by 7 and 7 traffic channels are respectively allocated to 7 cells, FRF is 7. In this case, a bundle of 7 cells to which different frequencies are allocated is called a cell cluster. Therefore, FRF denotes the number of cells included in a cell cluster. That is, FRF indicates the characteristics of frequency bands used by respective cells in a multi-cell environment.

FIG. 1 illustrates the use of frequencies when 1, 3 and 7 are used as FRF. Numerals indicated in cells are separators for specific frequency bands. The case where FRF is 1 means that all cells use the same frequency band. When FRF is 1, the amount of data usable in one band is large, but all cells use the same frequency, and thus ICI excessively increases. In contrast, when FRF is high, ICI decreases, but there is a disadvantage from the standpoint of frequency efficiency. Therefore, in the present invention, a description will be made on the assumption that, when FRF is 7, ICI can be minimized.

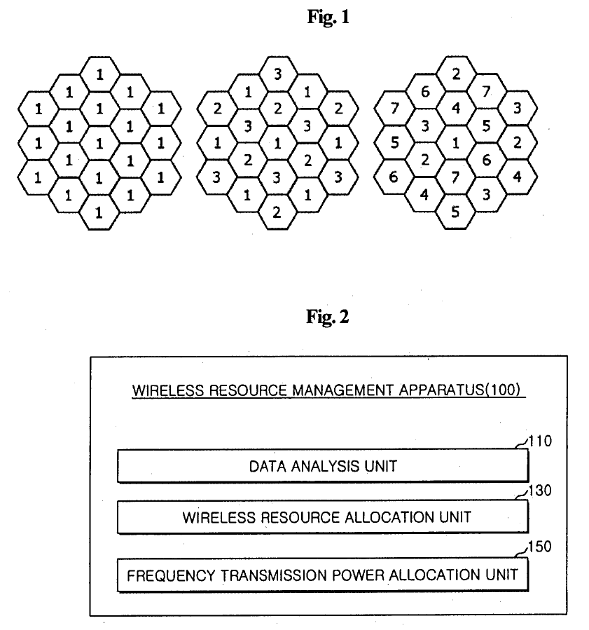

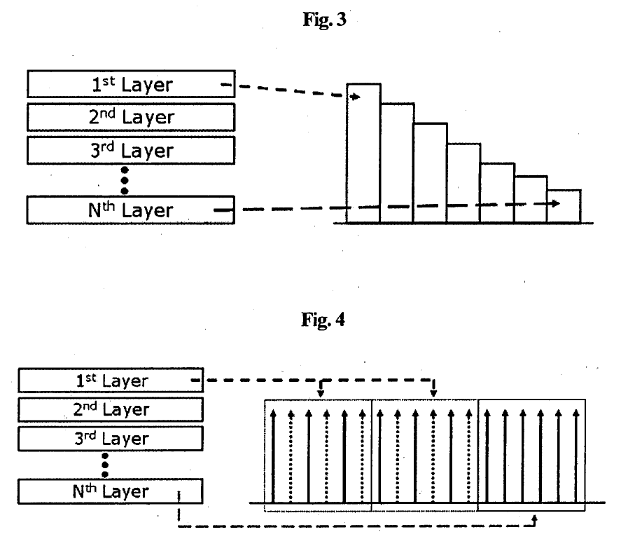

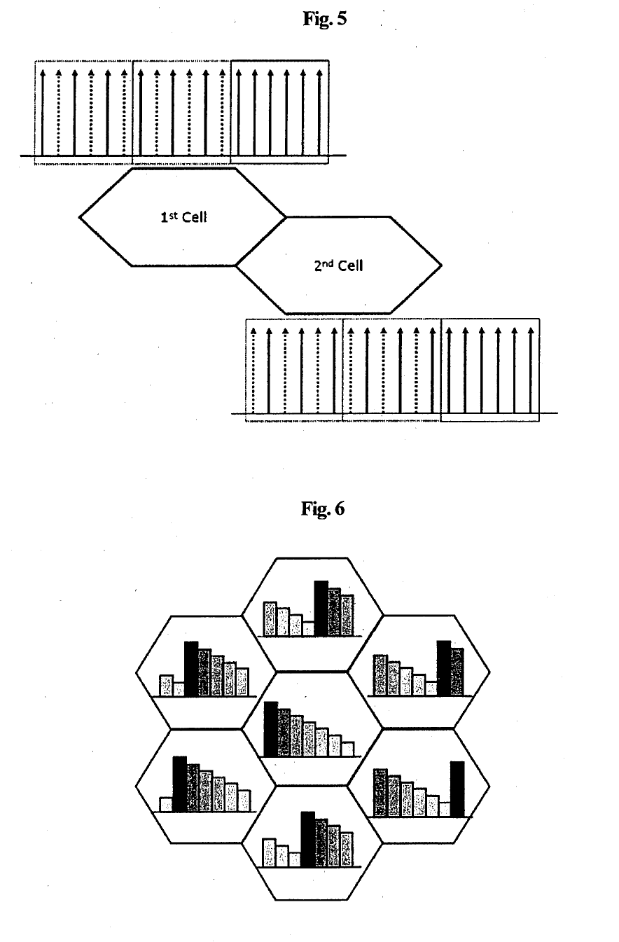

FIG. 2 is a detailed diagram showing the construction of an apparatus for managing wireless resources. The wireless resource management apparatus is described in detail with reference to FIG. 3 illustrating a method of allocating bit stream layers to frequency bands, FIG. 4 illustrating a method of allocating bit stream layers to frequency bands having different subcarrier densities, FIG. 5 illustrating an example in which the method of FIG. 4 is applied to two cells, and FIG. 6 illustrating an example in which the method of FIG. 3 is applied to multiple cells.

As shown in the drawings, a wireless resource management apparatus 100 includes a data analysis unit 110, a wireless resource allocation unit 130, and a frequency transmission power allocation unit 150, and is operated to allocate frequency bands or control the intensity of transmission power at each frequency on the basis of the amount of multimedia information of an application layer.

In detail, the data analysis unit 110 separates multimedia information into a plurality of bit stream layers, which form a layered structure, using a layered video compression codec capable of dividing the multimedia information into a plurality of bit stream layers, as shown in FIG. 3, and thereafter detects the amounts of information of respective bit stream layers. The detected amounts of information of respective bit stream layers are stored in the headers of the bit steam layers.

For example, a Signal to Interference and Noise Ratio (hereinafter referred to as an ‘SINR’) of any one subcarrier in a multi-subcarrier system is represented by the following Equation [1].

$$SINR = \frac{S \cdot L}{{I}_{SC} + {I}_{OC} + {N}_{O}} \qquad [ 1 ]$$

In this case, SINR is the ratio of the received strength of a desired signal to the received strength of an undesired signal (noise or interference), where S is the power of a subcarrier, L is a link gain, I_{SC} is intra-cell interference, I_{OC} is inter-cell interference, and N_{O} is noise.

The channel capacity C guaranteed according to SINR in Equation [1] is expressed by the following Equation [2],

C=BW·log(1+SINR) [2]

where BW denotes the frequency band of a subcarrier, and channel capacity at this time is considered in relation to data rate R. The data rate of multimedia can be represented by the following Equation [3] in relation to the amount of information.

$$R = {\sum }_{aILX} H ( X ) \qquad [ 3 ]$$

In Equation [3], X denotes multimedia represented by a random variable. In this case, the sum total of the random variable required to represent multimedia is identical to a data rate. When it is assumed that a channel capacity is identical to a data rate, the management of wireless resources can be performed from the standpoint of a data rate.

That is, the maximization of a channel capacity in a multi-channel subcarrier system means the maxim on of the amount of information, which is represented by the following Equation [4],

$$Max {\sum }_{k} {BW}_{k} \cdot log ( 1 + {SINR}_{k} ) = Max {\sum }_{k} {\sum }_{X} H ( X ) \qquad [ 4 ]$$

where k denotes a user index.

Methods of the wireless resource allocation unit 130 allocating bit stream layers, forming a layered structure, to frequency bands can be classified into a method of allocating a plurality of bit stream layers to different frequency bands, and a method of allocating the bit stream layers to frequency bands having different loading ratios. Further, the method of allocating bit stream layers to frequency bands having different loading ratios is a method considered to minimize interference from nearby cells in a wideband mobile communication network, which will be used in the future.

This operation is described in detail. As shown in FIG. 3, the wireless resource allocation unit 130 allocates a plurality of bit stream layers to different frequency bands on the basis of the amounts of information of respective bit stream layers analyzed by the data analysis unit 110. For reference, the classification of data in the order of a first layer, a second layer, etc. is based on importance. The first layer means the layer having the highest importance. Such a classification method is also applied to the case where the wireless resource allocation unit 130 allocates bit stream layers to frequency bands.

Second, as shown in FIG. 4, the wireless resource allocation unit 130 allocates bit stream layers, analyzed by the data analysis unit 110, to frequency bands having different loading ratios. A bit stream layer having a largest amount of information is allocated to a frequency band having a relatively low subcarrier distribution, whereas a bit stream layer having a small amount of information is allocated to a frequency band having a relatively high subcarrier distribution. For example, the wireless resource allocation unit 130 obtains a solution of Equation [4], calculated by the data analysis unit 110, for the allocation of frequency bands, and allocates the bit steam layers to frequency bands using the solution.

For reference, in FIG. 4, the classification of data in the order of a first layer, a second layer, etc., is based on importance. The first layer means a layer having the highest data importance. The wireless resource allocation unit 130 allocates the first layer having the highest data importance to a frequency band having the lowest subcarrier distribution (density)(that is, the first frequency band and second frequency band of FIG. 4), thus decreasing interference from nearby cells.

For example, as shown in FIG. 5, when frequency bands having a relatively low subcarrier distribution are allocated to two cells, there is the disadvantage of frequency efficiency, but the advantage of the reduction of interference between cells can be expected.

The frequency transmission power allocation unit 150 allocates transmission power at frequency in consideration of the amount of information of the bit stream layer carried in a specific frequency. The frequency on power allocation unit 150 uses the concept of FRF indicating that different transmission power patterns are respectively allocated to cells, other than a concerned cell, in a situation in which multiple cells are adjacent to each other, as shown in FIG. 6. If the strengths of transmission power are differently allocated to respective cells in this way, ICI occurring in the outer portions or boundaries of cells can be greatly reduced.

For example, the frequency transmission power allocation unit 150 obtains a solution of Equation [4], calculated by the data analysis unit 110, for frequency transmission power, and determines the strength of frequency transmission power using the solution.

FIG. 7 is a flowchart of a method of managing wireless resources according to an embodiment of the present invention.

First, the data analysis unit 110 of the wireless resource management apparatus 100 separates multimedia information into a plurality of bit stream layers, which form a layered structure, using a layered video compression codec capable of dividing the multimedia information into bit stream layers at step S101.

Next, the data analysis unit 110 detects the amounts of information of respective bit stream layers separated at step S101, and stores the detected amounts of information in the headers of corresponding bit stream layers at step S103.

The wireless resource allocation unit 130 equally divides the entire frequency band by the number of bit stream layers separated at step S101, allocates the bit stream layers to different frequency bands on the basis of the amounts of information of the bit stream layers detected at step S103, and transmits the bit stream layers through respective frequency bands at step S105. In this case, when the bit stream layers are transmitted, the strength of frequency transmission power to be carried in each frequency band is determined using the optimization algorithm of Equation [4], calculated by the data analysis unit 110, after the amounts of information of corresponding bit stream layers desired to be transmitted have been determined by the frequency transmission power allocation unit 150.

The amounts of information of the bit stream layers can also be obtained in consideration of a plurality of weights at the request of a user.

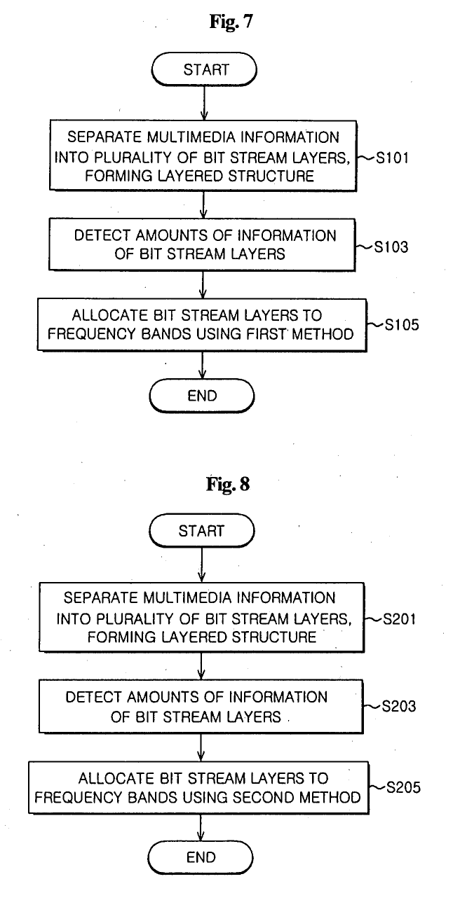

FIG. 8 is a flowchart of a method of managing wireless resources according to another embodiment of the present invention.

First, the data analysis unit 110 of the wireless resource management apparatus 100 separates multimedia information into a plurality of bit stream layers using a layered video compression codec capable of separating the multimedia information into bit stream layers at step S201.

Next, the data analysis unit 110 detects the amounts of information of respective bit stream layers separated at step S201, and stores the detected amounts of information in the headers of corresponding bit stream layers at step S203.

The wireless resource allocation unit 130 divides the entire frequency band by the number of bit stream layers separated at step S201, and allocates specific bit stream layers to frequency bands having different loading ratios on the basis of the amounts of information of the bit stream layers detected by the data analysis unit 110 at step S205.

In this case, the wireless resource allocation unit 130 allocates a bit stream layer having a largest amount of information to a frequency band having a relatively low subcarrier distribution (density), and a bit stream layer having a small amount of information to a frequency band having a relatively high subcarrier distribution.

The apparatus for managing wireless resources disclosed in the present invention is implemented as an independent device in the above embodiments, but can be integrated into a single system together with any one of components (for example, a base station or the like) in a mobile communication system to manage wireless resources.

### MODE FOR INVENTION

### Industrial Applicability

As described above, an apparatus and method for managing wireless resources according to the present invention is advantageous in that it can reduce interference between cells at the time of transmitting data, from the standpoint of an application layer that directly influences users.

Further, the present invention is advantageous in that it can increase the channel capacity of all cells when data is transmitted.

Those skilled in the art will appreciate that the present invention can be implemented as other embodiments, without departing from the technical spirit and essential features of the invention, so that the above embodiments are only exemplary, but are not limiting. The scope of the present invention is defined by the accompanying claims rather than the detailed description. All changes or modifications that can be derived from the meaning and scope of the claims and equivalent concepts thereof should be interpreted as being included in the scope of the present invention.

1. An apparatus for managing wireless resources, comprising:
a data analysis unit for separating data into a plurality of bit stream layers, which form a layered structure, by analyzing the data according to a predetermined rule, and for detecting amounts of information of respective bit stream layers; and
a wireless resource allocation unit for allocating the bit stream layers to frequency bands based on the amounts of information of the bit stream layers detected by the data analysis unit.

2. The apparatus according to claim 1, further comprising:
a frequency transmission power allocation unit for allocating frequency transmission power of the bit stream layer carried in a specific frequency based on the amounts of information of the bit stream layers detected by the data analysis unit.

3. The apparatus according to claim 2, wherein:
the data analysis unit calculates a signal to interference and noise ratio using power of a subcarrier, link gain, intra-cell interference, inter-cell interference, and noise, calculates a channel capacity guaranteed according to the signal to interference and noise ratio, calculates a data rate, which is a sum total required to represent multimedia information, using the channel capacity, and calculates a reference causing the amount of information to be maximized using the channel capacity and the data rate; and
the frequency transmission power allocation unit determines the frequency transmission power based on the reference.

4. The apparatus according to claim 2, wherein the frequency transmission power allocation unit allocates the frequency transmission power such that a plurality of cells has different transmission power patterns in a situation in which the plurality of cells are adjacent to each other.

5. The apparatus according to claim 1, wherein the data analysis unit detects the amounts of information of respective bit stream layers, and then stores the detected amounts of information in headers of corresponding bit stream layers.

6. The apparatus according to claim 1, wherein the wireless resource allocation unit allocates the bit stream layers to frequency bands in a descending order of importance using the amounts of information of the bit steam layers detected by the data analysis unit.

7. The apparatus according to claim 1, wherein:
the wireless resource allocation unit allocates the bit stream layers to frequency bands having different loading ratios based on the amounts of information of the bit stream layers detected by the data analysis unit in such a way that a bit stream layer having a largest amount of information is allocated to a frequency band having a low subcarrier distribution and a bit stream layer having a small amount of information is allocated to a frequency band having a high subcarrier distribution.

8. A method of managing wireless resources in a wireless resource management apparatus for allocating wireless resources to frequency bands according to an amount of information of data transmitted or received in a mobile communication system, comprising:
a first step of the wireless resource management apparatus separating multimedia information into a plurality of bit stream layers, which form a layered structure, using a layered video compression codec capable of separating multimedia information into bit stream layers;
a second step of detecting amounts of information of respective bit stream layers separated at the first step, and storing the detected amounts of information in headers of corresponding bit stream layers; and
a third step of dividing an entire frequency band by a number of bit stream layers separated at the first step, and allocating the bit stream layers to different frequency bands based on the amounts of information of the bit stream layers detected at the second step, and transmitting the allocated bit stream layers through respective frequency bands.

9. The method according to claim 8, wherein the third step is performed such that, when the bit stream layers are transmitted, strength of frequency transmission power to be carried in each frequency band is determined based on the amounts of information of corresponding bit stream layers desired to be transmitted.

10. A method of managing wireless resources in a wireless resource management apparatus for allocating wireless resources to frequency bands according to an amount of information of data transmitted or received in a mobile communication system, comprising:
a first step of the wireless resource management apparatus separating multimedia information into a plurality of bit stream layers, which form a layered structure, using a layered video compression codec capable of separating multimedia information into bit stream layers;
a second step of detecting amounts of information of respective bit stream layers separated at the first step, and storing the detected amounts of information in headers of corresponding bit stream layers; and
a third step of dividing an entire frequency band by a number of bit stream layers separated at the first step, and allocating the bit stream layers to frequency bands having different loading ratios based on the amounts of information of the bit stream layers detected at the second step.

11. The method according to claim 10, wherein the third step is performed such that a bit stream layer having a largest amount of information is allocated to a frequency band having a relatively low subcarrier distribution and a bit stream layer having a small amount of information is allocated to a frequency band having a relatively high subcarrier distribution.
